(19) United States
(12) Patent Application Publication
(10) Pub. No.: US 2026/0161685 A1
(43) Pub. Date: Jun. 11, 2026

(54) SELECTIVE GENERATION OF GENERATIVE CONTENT FOR PORTION(S) OF AN ELECTRONIC DOCUMENT

(71) Applicant: GOOGLE LLC, Mountain View, CA (US)

(72) Inventors: Karthik Srinivas, Bangalore (IN); Ramprasad Sedouram, Bangalore (IN); Sunil Samuel, Bengalore (IN); Ajay Prasad, Bangalore (IN)

(21) Appl. No.: 19/407,966

(22) Filed: Dec. 3, 2025

(30) Foreign Application Priority Data
Dec. 5, 2024 (IN) 202411095922

(51) Int. Cl. G06F 16/3329; G06F 16/34; G06F 40/169

(52) U.S. Cl. CPC G06F 16/33295; G06F 16/345; G06F 40/169

(57) ABSTRACT

Implementations selectively generate generative content, for portion(s) of an electronic document, and cause rendering, to a user via a client device, of the generated generative content. The rendering of the generative content can be in association with rendering of the electronic document at the client device. Some implementations automatically identify the portion(s) of the electronic document, automatically generate the generative content based on the identified portion(s), and/or automatically render the generative content or an indication of availability of the generative content. Various implementations can automatically identify portion(s), for an electronic document, based on historical interaction data that reflects historical interactions with the portion(s). Various implementations can additionally or alternatively utilize user engagement data in automatically identifying portion(s) for an electronic document or other content. The user engagement indicates a measure of engagement by a user with portion(s) of the content.

### BACKGROUND

Various generative models have been proposed that can be used to process natural language (NL) content, image(s), audio data, and/or other input(s) to generate output that reflects generative content (e.g., NL content, image(s), audio data) that is responsive to the input(s). For example, large language models (LLM(s)) have been developed that can be used to process NL content and/or other input(s), to generate LLM output that reflects NL content and/or other content that is responsive to the input(s). As another example, image generation models have been developed that can be used to process NL content to generate output that reflects an image that corresponds to the NL content. As yet another example, multimodal generative models have been developed that can process multiple types of input (e.g., NL content and images) and/or that can generate multiple types of output (e.g., NL content and images).

Various applications provide access to corresponding generative model(s). Those applications enable users to specify, via user interface input(s), input(s) that are to be processed using generative model(s) and cause rendering (e.g., graphical and/or audible) of generative content that is generated based on such processing.

Users have utilized such applications for various purposes. For example, a user can utilize such an application to generate generative content based on a portion of an electronic document that the user is viewing and/or listening to via a separate application. For instance, a user can be reading a lengthy article in a web browser application and encounter a complex paragraph that the user is having trouble comprehending. The user can utilize multiple inputs to highlight and copy the content, then switch from the web browser application to the generative model application, then utilize multiple inputs to formulate a generative model prompt based on the content (e.g., type “provide an easier to comprehend version of the following paragraph:” and paste the copied content following “:”), then submit the generative model prompt and wait for generative content, that is generated based on processing of the generative model prompt, to be rendered.

These and other utilizations of generative models can suffer from one or more drawbacks. For example, such utilizations can require a large quantity of user inputs to cause generation of the generative content, which can be cumbersome and/or prolong a human-to-computer interaction. As another example, such utilizations can require self-recognition, by a corresponding user, that generative content can be useful, which takes time and prolongs a human-to-computer interaction. As yet another example, such utilizations can require switching between multiple different applications, such as between a first application rendering an electronic document and a second application that provides access to a generative model. This can be cumbersome on mobile phones or other client devices with constrained screen sizes and/or can prolong a human-to-computer interaction. As yet a further example, such utilizations can require live processing of a lengthy generative model prompt to generate the generative content, which can be computationally burdensome and/or introduce latency.

### SUMMARY

Implementations disclosed herein are directed to selective generation of generative content, for portion(s) of an electronic document, and causing rendering, to a user via a client device, of the generated generative content. The rendering of the generative content can be in association with rendering of the electronic document at the client device. For example, the rendering of the generative content can be simultaneous to rendering of the electronic document and can be performed by the same application that is rendering the electronic document or by another application, but overlaid atop the rendering of the electronic document. Some of those implementations: automatically (i.e., independent of any explicit user input of the user) identify the portion(s) of the electronic document, automatically generate the generative content based on the identified portion(s), and/or automatically render the generative content or an indication of availability of the generative content (e.g., a GUI element that, when selected, causes generative content to be rendered). A quantity of user inputs and/or a duration of a human-computer interaction can be reduced through such automatic identification of the portion(s), automatic generation of the generative content, and/or automatic rendering of the generative content or the indication of availability.

As described herein, various implementations can automatically identify a portion, for an electronic document, based on historical interaction data that reflects historical interactions with the portion, such as historical interactions with the portion by multiple users. For example, some of those various implementations can identify a portion of an electronic document based on historical interaction data indicating a majority of users, that interacted with the electronic document, spent more time reviewing that portion than reviewing other portion(s) of the electronic document. Further, some of those various implementations can automatically generate generative content based on the identified portion and, optionally, based on type(s) of interactions indicated by the historical interaction data. For example, the generative content can be generated based on a prompt that includes the portion and, optionally, that includes instructional language of “make the following content more understandable”, “summarize the following content in an understandable manner”, or similar. For instance, the instructional language that specifies summarization and/or understandability can be included based on the historical interaction data indicating that users spent more time reviewing the portion. In contrast, and as another instance, instructional language that specifies expansion and/or support (e.g., “expand on the following content and provide examples of support”) can instead be included based on the historical interaction data instead indicating that users, in interacting with the electronic document, frequently copied the portion and issued searches based on the copied portion.

Through consideration of historical interaction data in identifying portion(s) of an electronic document and/or in generating generative content for identified portion(s), implementations can ensure that, at least in aggregate, generating generative content therefore and causing rendering of the generative content achieves technical benefits. For example, such considerations can ensure that, in aggregate, that automatically generating generative content for portion(s) and automatically causing rendering of the generative content (or an indication thereof), shortens durations of human-to-computer interactions and/or lessens a quantity of user inputs that would otherwise be provided in human-to-computer interactions. Put another way, such considerations can ensure that generative content is generated and/or provided in situations where, absent techniques disclosed herein, a user would have otherwise less efficiently caused generation of similar generative content and/or would have otherwise performed other less efficient action(s) to obtain other similar non-generative content.

As also described herein, in some implementations where historical interaction data is utilized to automatically identify a portion of an electronic document, at least some of the processing, that is needed for generating generative content for rendering at a client device in response to the client device accessing the electronic document, is performed prior to any access of the electronic document by the client device.

For example, prior to any access, the to-be rendered generative content can already be generated based on a prompt that includes the portion and, optionally, instructional language that is based on the historical interaction data. For instance, the to-be-rendered generative content can already be generated and stored in association with the electronic document and the portion, and retrieved and caused to be rendered responsive to access of the electronic document (and optionally rendering of the portion) by the client device.

As another example, prior to any access of the electronic document an initial prompt can already be generated that includes the portion and, optionally, instructional language based on the historical interaction data. The initial prompt can be retrieved responsive to access of the electronic document and refined, to generate a refined prompt, based on data that is specific to the client device and/or a user of the client device. For instance, the refined prompt can add, to the initial prompt, a description of a current location of the client device, a description of a search issued at the client device in navigating to the electronic document, and/or descriptor(s) of attribute(s) and/or preference(s) of the user. The refined prompt can then be caused to be processed, using a generative model, to generate the generative content.

As yet another example, prior to any access, initial generative content can already be generated based on a prompt that includes the portion and, optionally, instructional language based on the historical interaction data. For example, the initial generative content can be a summary of a complex paragraph that describes intricacies of Q-learning and can be generated based on a prompt that is of the form “generate a shortened and easier to understand version of [portion]”. The initial generative content can be retrieved responsive to access of the electronic document and an additional prompt generated that includes the initial generative content and further content that is specific to the client device and/or a user of the client device. For example, the further content can include further content that reflects the user is familiar with machine learning and the additional prompt can be of the form “tailor the following content so that it is appropriate for someone familiar with machine learning: [initial generative content]”. The additional prompt can then be caused to be processed, using a generative model, to generate the generative content.

Latency in generating the generative content and, resultantly, in providing the generative content, is reduced in these and other situations where at least some of the processing, that is needed for generating generative content, is performed prior to any access of the electronic document by the client device. Moreover, various computational resources are conserved in these and other situations by mitigating the need to perform the full extent of processing, needed for generating generative content, in response to each access of the electronic document. For example, a single instance of generating generative content can be performed, and that resulting generative content provided to multiple client devices responsive to multiple accesses of the electronic document.

As also described herein, various implementations can additionally or alternatively utilize user engagement data in automatically identifying a portion for an electronic document or other content. The user engagement data indicates a measure of engagement, with portion(s) of the content, by a user of the client device. For example, the user engagement data for a portion of content can indicate a binary measure that indicates whether the user engaged with that portion or can be a non-binary measure (e.g., from 0 to 1) that indicates an extent of engagement with that portion (e.g., with 0 being non-engaged and 1 being most engaged).

In some implementations, the user engagement data reflects interaction(s) by the user during rendering of the content. In some versions of those implementations, the user engagement data can include data that is based on interaction(s), by the user, with an application that is rendering the content. For example, if the content is a video being rendered via an application, the user engagement data can be based on one or more occurrences of the user interacting with the application to rewind the video to rewatch a certain portion of the video. As another example, if the content is a lengthy article, the user engagement data can based on the user very quickly scrolling past the portion of the article.

In some additional or alternative versions of those implementations, the user engagement data can include data generated based on sensor data from one or more sensors in an environment with the user.

For example, the user engagement data can be based on sensor data from sensor(s) of wearable device(s) worn by the user. For instance, the sensor data can include sensor data from vision-based sensor(s), of smart glasses, that are directed toward the user's eyes and the sensor data can indicate an extent to which the user's eyes are directed to an electronic document being rendered. As a particular instance, if the electronic document is a video and is being rendered via the smart glasses (e.g., via a projection display thereof) or is being rendered via a separate device (e.g., a separate tablet), the sensor data can indicate the user's eyes were not directed toward the video for a 30 second segment of the video, thereby indicating non-engagement.

As another example, the user engagement data can be based on sensor data from sensor(s) of the client device itself. For instance, the sensor data can include sensor data from a presence sensor, of the client device, that indicates whether any user is present near (i.e., within a detection threshold) the client device at a given time and/or can includes sensor data from a camera, of the client device, that indicates whether a user is present and looking at the client device at a given time. As a particular instance, if the electronic document is a video and is being rendered via the client device, the sensor data can include sensor data from a presence sensor, of the client device, and can indicate the user was not present during a 2 minute segment of the video.

As another example, the user engagement data can be based on sensor data from Internet of things (IoT) device(s) in a home of the user, such as a smart doorbell, a smart lock, a smart refrigerator, a smart light, a smart camera, and/or other smart device(s). For instance, the sensor data can include sensor data from a smart lock and/or a smart doorbell that indicates the user interacted with an arriving guest during a period of time, thereby indicating non-engagement with content being rendered during the period of time.

Through consideration of user engagement data in identifying portion(s) of an electronic document and/or in generating generative content for identified portion(s), implementations can ensure that generating generative content therefore and causing rendering of the generative content achieves technical benefits. For example, such considerations can ensure that engagement data indicates that automatically generating generative content for portion(s) and automatically causing rendering of the generative content (or an indication thereof), will shorten a duration of the ongoing human-to-computer interaction and/or lessen a quantity of user inputs that would otherwise be provided in the human-to-computer interaction. Put another way, such considerations can ensure that generative content is generated and/or provided in situations where, absent techniques disclosed herein, a user would have otherwise less efficiently caused generation of similar generative content and/or would have otherwise performed other less efficient action(s) to obtain other similar non-generative content.

In various implementations, historical user engagement data may be identified and stored in response to determining user engagement by one or more users with content. Historical user engagement data may identify user engagement with given portions of content relative to other portions of content. For example, historical user engagement may identify an average time spent by a user engaging with portions of content and may identify deviations from the average time on given portions. A scenario might include identifying that a user has averaged 2 minutes per section of an article for the first three sections, but has accumulated 4 minutes while engaging with the fourth section. Historical user engagement data may be utilized to determine when subsequent engagements with a given portion of content (by the same user, and/or by another user) warrants suggesting or automatically providing generative content that may supplement the given portion of content. For example, if users are consistently spending an average of 2 minutes per section on multiple sections, but that time doubles here or there for given sections (e.g., users spend 4+ minutes), then generative content may be suggested to aid users in understanding the given sections.

In various implementations, user engagement data can additionally or alternatively be used to identify current engagement, or lack of engagement, of a user with a portion of content. User engagement data can be determined based on real-time sensor data from one or more sensors of a device. User engagement data can reflect explicit inputs from a user, inferred engagement of a user, and/or inferred lack of engagement of a user. For example, explicit inputs can include natural language inputs, haptic inputs, audible inputs, graphical inputs, etc., that are intentionally provided by a user. Inferred engagement can include, for example, eye movement, heart rate, head orientation, facial contortion, and/or exhausted exhales, etc. that can be used to determine user engagement.

Various practical scenarios in which technology disclosed herein can be implemented will be discussed herein. As one non-limiting example, a processor can process user input data in furtherance of identifying user engagement in the form of highlighting a given portion of content, re-reading a given portion of content, etc., is higher for the given portion of content relative to other portions of the content, and generative content in the form of a summarization, expansion, and/or media conversion of the given portion can be automatically provided or suggested based on such. As another non-limiting example, a processor can process user input data in furtherance of identifying that a user was not present during rendering of real-time content, such as a basketball game, and generate generative content in the form of a recap can be suggested or automatically provided based on the lack of user engagement. As yet another non-limiting example, a processor can process user input data in furtherance of identifying a quality metric of content, and generative content may or may not be suggested based on the identified quality metric (e.g., recapping a missed portion of a meeting if important details were discussed, but not recapping the missed portion if details were not discussed).

The above description is provided as an overview of some implementations of the present disclosure. Further description of those implementations, and other implementations, are described in more detail below.

### BRIEF DESCRIPTION OF THE DRAWINGS

FIG. 1 depicts an example environment in which implementations discussed herein may be implemented.

FIG. 2 depicts a process flow associated with implementations discussed herein from a client device perspective.

FIG. 3 depicts another process flow associated with implementations discussed herein from a remote system perspective.

FIG. 4 depicts a flow chart illustrating an example method according to implementations disclosed herein.

FIG. 5 depicts another flow chart illustrating another example method according to implementations disclosed herein.

FIG. 6A, FIG. 6B, FIG. 6C, and FIG. 6D depict an environment in which user engagement with content is determined and generative content is suggested based on the determined user engagement.

FIG. 7A, FIG. 7B, FIG. 7C, and FIG. 7D depict another environment in which user engagement with content is determined and generative content is suggested based on the determined engagement.

FIG. 8 depicts an example architecture of a computing device, in accordance with various implementations.

### DETAILED DESCRIPTION

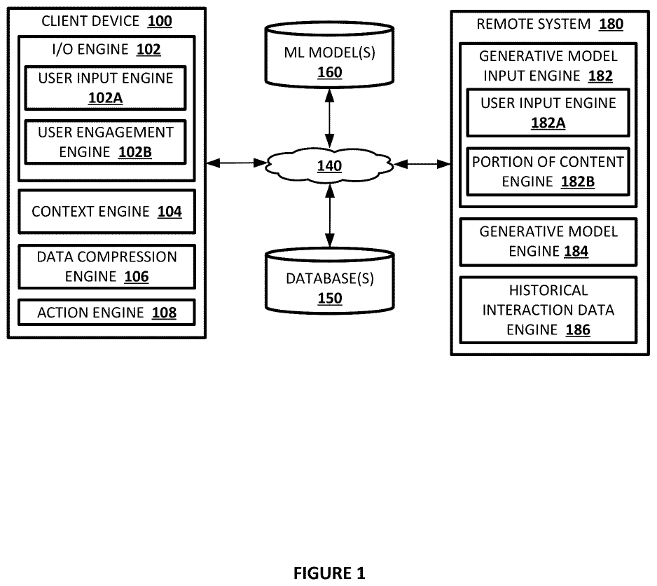

FIG. 1 depicts an example environment in which implementations disclosed herein may be implemented. A client device 100 is illustrated in FIG. 1. Client device 100 may include one or more engines and/or be connected to one or more networks (e.g., network 140). Client device 100 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided. Further, network 140 may include, for example, any combination of Wi-Fi®, Bluetooth®, or other local area networks (LANs); ethernet, the Internet, or other wide area networks (WANs); and/or other networks.

Client device 100 may include input/output (I/O) engine 102. I/O engine 102 may determine, process, generate, and/or transmit one or more inputs and/or outputs. I/O engine 102 may include user input engine 102A and/or user engagement engine 102B. Inputs and/or outputs may be provided by and/or derived from a user and/or a computing device.

User input engine 102A may identify, process, generate, and/or transmit one or more inputs that are provided by and/or derived from the user. Inputs may include at least one or more of visual, audible, and/or haptic inputs via at least one or more of a graphical, audio, and/or keyboard interfaces of a computing device, and may include inputs from the user that are intentionally provided in furtherance of causing an automated assistant to perform an action (e.g., a natural language request, etc.) and/or inputs from the user that are not intentionally and/or explicitly provided in furtherance of causing an automated assistant to perform an action (e.g., looks of confusion, etc.). Inputs may be captured via one or more device sensors, including cameras, microphones, haptic sensors, heart-rate sensors, eye-tracking sensors, etc. Additionally, one or more models, may be used to process captured inputs, including facial recognition models, gesture recognition models (e.g., for looks of confusion), non-natural language input models (e.g., for audible exhaustive exhales), etc.

User engagement engine 102B may identify user engagement with content being rendered by one or more devices. For example, user engagement engine 102B may identify whether a user is and/or is not engaging with content being rendered by one or more devices. For example, user engagement engine 102B may process inputs from the user, including inputs that are not intentionally provided in furtherance of causing an automated assistant to perform an action, in furtherance of determining user engagement with given portions of content. User engagement engine 102B may use one or more models, such as the gesture recognition models (e.g., for looks of confusion), non-natural language input models (e.g., for audible exhaustive exhales), etc., in furtherance of determining whether inputs from the user that are not intentionally provided in furtherance of causing an automated assistant to perform an action, are indicative of user engagement, and are appropriate for use in causing generative content to be generated.

I/O engine 102 may identify, process, generate, render, and/or transmit one or more outputs provided by and/or derived from the client device 100 and/or the user. Outputs may include graphical outputs rendered by a display of one or more devices, audible outputs rendered by speaker(s) of one or more devices, haptic outputs rendered by component(s) of one or more devices, and/or other outputs. I/O engine 102 outputs may also include data packets of one or more of user input engine 102A and/or user engagement engine 102B. For example, I/O engine 102 may include data packets of user input engine 102A, which may indicate natural language input from a user intentionally and/or explicitly provided in furtherance of causing an automated assistant to perform an action, and/or data packet of user engagement engine 102B, which may indicate input from a user that may not be intentionally and/or explicitly provided in furtherance of causing an automated assistant to perform an action.

Client device 100 may include context engine 104 which may generate context data. Context engine 104 may determine, process, generate, etc., context data that indicates a context associated with one or more of client device 100 and/or one or more users. For example, context engine 104 may identify content that is being rendered by client device 100 and/or another device. Context engine 104 may identify given portions of content that a user is engaging with (e.g., which user input such as gestures of confusion, eye movement, exhales, etc., may correspond to). Context data may bias client device 100 (including engines thereof). For example, context data may bias I/O engine 102, such that input data received, identified, and/or generated by I/O engine 102 is processed differently with context data than without context data. As a scenario, context data may indicate a given portion of content that user input (e.g., gesture of confusion, exhausted exhale, etc.) may correspond to, and may cause I/O engine 102 to process user input data based on this context (e.g., based on the given portion, as opposed to another portion). As another scenario, context data may indicate that no content is being rendered and/or irrelevant content is being rendered, and may cause I/O engine 102 to process user input data independent of processing any content.

Context engine 104 can additionally or alternatively identify an environmental context of client device 100 (and/or a user thereof), including related weather, location, orientation, and/or other context associated with client device 100. Context data identified by context engine may indicate a current time and/or location of client device 100. Context data may additionally or alternatively indicate a user's knowledge level, e.g., regarding topics that given portions of content related to. Context data may may additionally or alternatively indicate a user's preferences, e.g., regarding when and/or if to provide a generative content suggestion, a media type for generative content, length of generative content, depth of generative content, and/or social prominence (e.g., obscure, popular) of features included in the generative content.

Client device 100 may include a data compression engine 106. Data compression engine 106 may compress data of client device 100 (in whole and/or in part). Data compression engine 106 may compress data before transmitting it to a remote system. Compression of data by data compression engine 106 may reduce a size of data relative to a non-compressed size of data. Correspondingly, compression of data may further reduce computational and network strain associated with transmission and processing of large amounts of data, such as image data and/or other forms of vision data. Data compression engine 106 can be omitted in various implementations.

Client device 100 may include an action engine 108. Action engine 108 may cause one or more actions to be performed by client device 100 and/or another computing device. Action engine 108 may cause an action to occur based on processing data. Put another way, action engine 108 may cause an action to occur based on processing data identified and/or generated by client device 100 and/or remote system 180. For example, remote system 180 may generate generative content data and transmit the generative content data to client device 100, and action engine 108 may cause I/O engine 102 to render output for a user based on the generative content data and via one or more interfaces of one or more devices. Action engine 108 may additionally or alternatively cause one or more other actions to be performed by one or more other devices, such as turning a device on/off, adjusting settings (e.g., volume, brightness, timers, etc.) of a device, adjusting connections of a device, etc. Scenarios may include action engine 108 causing an action of rendering generative content via client device 100 to be performed, and an action of adjusting volume and/or brightness of client device 100 to be performed prior to, concurrently with, and/or subsequent to rendering the generative content.

Network 140 may connect client device 100 with other components that are also connected to network 140. Other components may be connected via network 140 and may or may not be directly connected to client device 100. Other components may include database(s) 150, machine learning model(s) 160, and remote system 180. Components connected to network 140 (including client device 100) may be constantly or periodically connected to network 140. Data transmitted over network 140 may be temporarily stored. For example, client device 100 may temporarily connect to network 140, transmit data over network 140, and disconnect from network 140, and the transmitted data may be temporarily stored (e.g., by instruction from client device 100 or by instruction from one or more other components connected to network 140). Adding to this example, subsequent to client device 100 transmitting data and disconnecting from network 140, remote system 180 may connect to network 140, and the temporarily stored data may be transmitted to remote system 180. Some components connected to network 140 may only be accessible by an exclusive subset of other components on network 140. For example, machine learning models 160, while on network 140, may only be accessible by remote system 180 and may not be accessible by client device 100, despite both remote system 180 and client device 100 both being on network 140. Additionally, or alternatively, an instance of the machine learning models 160 may be stored locally in memory of client device 100.

Network 140 may be connected to one or more databases 150. Database(s) 150 may include historical interaction data, which may indicate one or more historical interactions by one or more users. For example, historical interaction data may indicate user inputs that are explicitly and/or intentionally provided in furtherance of causing an automated assistant to perform an action (e.g., explicit natural language requests), and may indicate user input that are not explicitly and/or intentionally provided in furtherance of causing an automated assistant to perform an action (e.g., retinal scans). Further, historical interaction data may include feedback from a user and/or one or more devices responsive to an action performed by an automated assistant.

Network 140 may provide access to one or more machine learning models 160. Machine learning models 160 can include one or more generative models that can be utilized to generate generative content described herein. For example, machine learning models 160 can include LLM(s), image generation model(s), multimodal generative model(s), and/or other generative model(s).

Remote system 180 (e.g., a high performance server or a cluster of high performance servers) may be connected to network 140 via which remote system 180 and client device 100 may interact. Remote system 180 may handle requests received by remote system 180, such as a request to process data from client device 100 in furtherance of generating generative content data. Remote system 180 may determine whether or not to handle a particular request. A determination of whether or not to handle a particular request may be based on one or more factors, such as bandwidth, available processing capabilities, time of day, clients currently being or expected to be served, client device location, data size, etc.

Remote system 180 may include generative model input engine 182. Generative model input engine 182 may generate prompt data to provide to generative model engine(s) 184. Prompt data may be generated based on one or more of data received from client device 100 and/or data received from database(s) 150. Generative model input engine 182 may receive one or more of data from client device 100, another device, another remote system, and/or data from database(s) 150. For example, generative model input engine 182 may receive historical interaction data from database(s) 150, which may indicate historical engagement by one or more users with content. As another example, generative model input engine may also receive compressed data from client device 100, which may indicate user input and/or a current user engagement with content.

Remote system 180 may include generative model engine(s) 184, which may receive prompt data from generative model input engine 182 and may generate generative content data 208 based on processing the prompt data. For example, prompt data may include one or more prompts, which when processed by generative model engine(s) 184, cause generative model engine(s) 184 to output generative content data which may be processed by client device 100 in furtherance of rendering generative content for a user to improve content consumption and/or engagement.

Remote system 180 may also include historical interaction data engine 186, which may receive data from database(s) 150. Historical interaction data engine 186 may process the received data in furtherance of identifying and/or generating historical interaction data associated with one or more users who engaged with content. Historical interaction data engine 186 may provide data received from database(s) 150 and/or generated by historical interaction data engine 186 (based on the received data) to generative model input engine 182 for processing and/or provide the received data directly to generative model engine(s) 184 for processing.

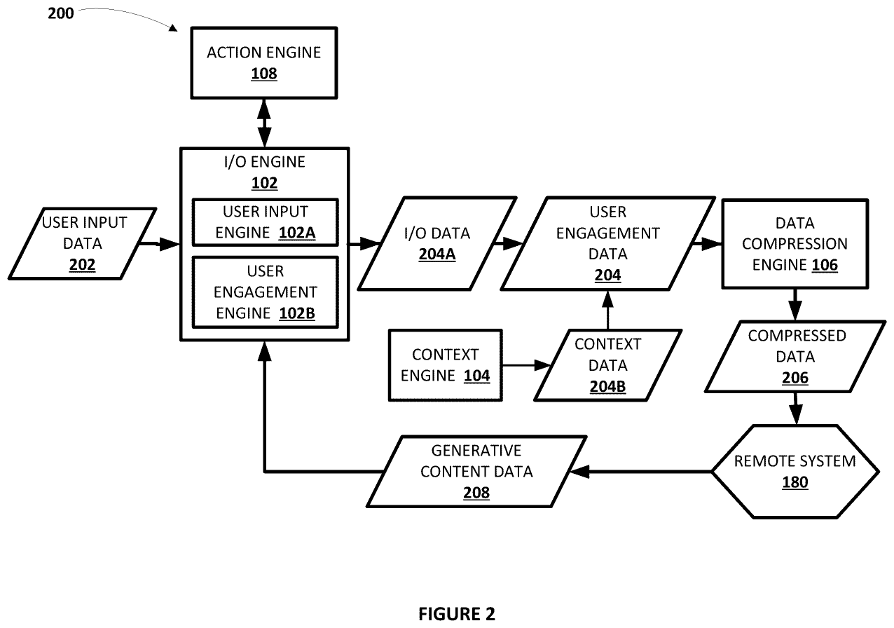

FIG. 2 depicts a process flow associated with implementations disclosed herein from a client device perspective.

User input data 202 may be received by I/O engine 102. User input data 202 may include natural language input data, typed user input data, graphical user input data, etc. User input data 202 may also include user engagement input data which may indicate user engagement with content. As discussed above, while natural language input data, typed user input data, etc., may correspond with user input that is explicitly and/or intentionally provided in furtherance of causing an automated assistant to perform an action, other user input data, such as facial expression user input data, eye-tracking user input data, heart rate user input data, etc., may not correspond with user input that is explicitly and/or intentionally provided in furtherance of causing an automated assistant to perform an action. Rather, the other user input data may be a more subtle, less conscious, less intentional, and/or less explicit input by the user that is responsive to user engagement.

I/O engine 102 may receive user input data 202 via one or more graphical, audio, and/or haptic interfaces of client device 100 and/or another device. I/O engine 102 may process user input data 202 using user input engine 102A and/or user engagement engine 102B. For example, natural language user input (typed, spoken, signed, etc.) may be processed using user input engine 102A. As another example, other user input (retinal scans, heartrate monitoring, location monitoring, etc.), may be processed using user engagement engine 102B. I/O engine 102 may generate and/or identify I/O data 204A based on processing user input data 202 using one or more of user input engine 102A and/or user engagement engine 102B.

I/O data 204A may be received by data compression engine 106. I/O data 204A may include data which may be processed by a remote system, such as remote system 180. For example, remote system 180 may or may not be configured to process raw user input data 202, and I/O data 204A may be generated to include data that remote system 180 is configured to process. I/O data 204A may include both user input that was explicitly and/or intentionally provided by a user in furtherance of causing an automated assistant to perform an action and/or user input that is not explicitly and/or intentionally provided by a user in furtherance of causing an automated assistant to perform an action.

Context engine 104 may generate and/or identify context data 204B, which may also be received by data compression engine 106. Context engine may generate and/or identify context data associated with client device 100 and/or a user thereof. For example, context engine 104 may generate and/or identify context data indicating one or more of client device 100's and/or a user of client device 100's location, orientation, surrounding atmosphere, and/or other environment feature(s). For example, context engine 104 may generate and/or identify context data 204B indicating that client device 100 and/or a user thereof is currently travelling through an urban and/or loud environment. As another example, context engine 104 may generate and/or identify context data 204B indicating content being rendered which user input data 202 may correspond to. Context data 204B may be used by remote system 180 in furtherance of generating generative content data that is appropriate given this context (e.g., generating audible output that a user can listen to with earbuds in while travelling through a loud environment, as opposed to generating visual output that would require a user to look at a device while travelling). Context data 204B may be generated independent of user input data. For example, context data 204B indicating location, orientation, speed, acceleration, rotation, etc., of client device 100 may be generated and/or identified independent of input from a user.

I/O data 204A and/or context data 204B may be included in user engagement data 204. In some implementations, user engagement data 204 may only include one or more of I/O data 204A and/or context data 204B.

Data compression engine 106 may receive user engagement data 204 (which as discussed above, may include I/O data 204A and/or context data 204B). Data compression engine 106 may compress features of data to make transmission of data from client device 100 to remote system 180 more efficient. For example, data compression engine 106 may encode features of data to reduce data file sizes in furtherance of decreasing latency of exchanges between client device 100 and remote system 180. Data compression engine 106 may generate compressed data 206 which may be transmitted to other devices and/or systems, such as remote system 180.

Remote system 180 (disclosed in more detail subsequently, via FIG. 2) may cause generative content data 208 to be transmitted to client device 100. For example, I/O engine 102 may receive generative content data 208 transmitted by remote system 180.

Action engine 108 may receive generative content data 208 and/or data derived therefrom from I/O engine 102. Action engine 108 may identify one or more actions based on data received. For example, action engine 108 may identify one or more actions for rendering suggestions based on generative content data 208, including actions for rendering suggestions via a graphical interface, audible interface, etc. Action engine 108 may also identify one or more actions to take prior to, concurrently with, and/or subsequently to rendering a suggestion, such as turning a device on/off, executing a search query, adjusting settings (e.g., volume, brightness, etc.). Put another way, prior to rendering suggestions regarding generative content, action engine 108 may adjust a volume level to a safe level for a user. Action engine 108 may identify and/or generate data to provide to I/O engine 102, which may cause one or more interfaces of client device 100 to render output. For example, action engine 108 may generate data (based on generative content data 208), which when processed by I/O engine 102 causes generative content to be rendered via one or more interfaces of client device 100.

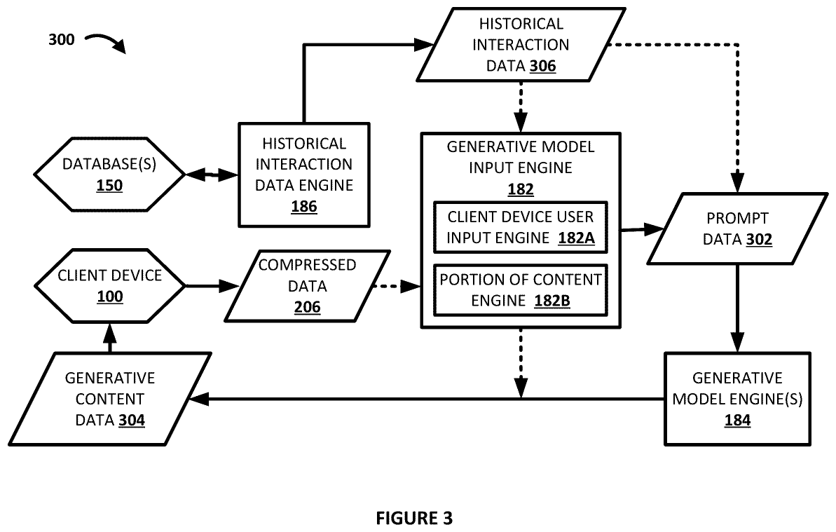

FIG. 3 depicts another process flow associated with implementations disclosed herein from a remote system perspective. Remote system 180 may receive compressed data 206. Compressed data 206 may be received by generative model input engine 182, which may include client device user input engine 182A and/or portions of content engine 182B.

In some implementations, client device user input engine 182A may process compressed data 206 in furtherance of identifying user input and/or engagement by a user with one or more portions of content. For example, client device user input engine 182A may identify features of user input that are explicitly and/or intentionally provided in furtherance of causing an automated assistant to perform an action, and/or identify features of user input that are not explicitly and/or intentionally provided in furtherance of causing an automated assistant to perform an action. In a scenario, client device user input engine 182A may identify a natural language request by a user, and/or a retinal scan of a user's eye (e.g., that is re-reading a given portion of content multiple times), which may indicate engagement by a user with a given portion of content. Accordingly, client device user input engine 182A may process compressed data 206 in furtherance of identifying and/or generating prompt data 302 to provide to generative model engine(s) 184.

Portion of content engine 182B may process compressed data 206 in furtherance of determining a given portion of content that a user is and/or is not engaging with. In some implementations, client device user input engine 182A may process compressed data 206 in furtherance of identifying content that is being rendered for a user and/or that user input may correspond to. As discussed previously, compressed data 206 may include data indicative of context data 204B, which may indicate a given portion of content being rendered and/or a given portion of content that a user is engaging with. Accordingly, portion of content engine 182B may identify a portion of content that compressed data 206 corresponds to based on processing compressed data 206.

In some implementations, compressed data 206 may not indicate a portion of content and portion of content engine 182B may receive additional data from an additional device. In a scenario, client device 100 may be wearable computing glasses and may include one or more sensors capable of identifying user input (e.g., input indicative of user engagement with content), and may be able to identify that content is being rendered by an additional device (e.g., TV, which the user is watching through the wearable computing glasses), but may not be able to identify specific content being rendered at an additional device (e.g., what channel, website, and/or other electronic document, is being rendered). Accordingly, portion of content engine 182B may also receive additional data from an additional device (e.g., the TV), and may determine that compressed data 206 corresponds to a given portion of content being rendered by the TV. Portion of content engine 182B may process compressed data 206 and/or additional data to identify a portion of content to include in prompt data 302 in furtherance of causing generative model engine(s) 184 to identify and/or generate generative content data 208 that is based on the identified portion of content.

In some implementations, remote system 180 may receive data from database(s) 150. Historical interaction data engine 186 may process data from database(s) 150 to identify and/or generate historical interaction data 306. Historical interaction data 306 may indicate one or more historical engagements by one or more users with content, and may include indications of engagement (and/or disengagement) with given portions of the content relative to other portions of the content. Put another way, historical interaction data 306 may indicate which given portions of content a historical user (which may or may not be the same as a current user) engaged with, did not engage with, requested supplementary information for, requested a summary of, requested an expansion of, requested alternative media explanations of, etc. As disclosed herein, some implementations may or may not include generation of generative content data based on historical interaction data 306. Put another way, some implementations herein may include generation of generative content data independent of historical interaction data 306.

Historical interaction data 306 may indicate temporal engagement metrics, engagement intensity metrics, engagement type metrics, and/or other engagement metrics. For example, historical interaction data 306 may indicate that one or more historical users (which may or may not be the same as one or more current users) may temporally engage with content for an average of 3 minutes per portion, but may spend a greater amount of time (e.g. 5 minutes) on a given portion of the content relative to other portions of the content, indicating that generative content should be generated (and possibly stored for later use) for the given portion of content. Historical interaction data 306 may also indicate that one or more historical users may engage with portions of content with a certain intensity and/or lack of intensity, for example, showing piqued interest via facial expressions, body movements, or other inputs, (or lack thereof). Historical interaction data 306 may further indicate that one or more historical users may engage with content via one or more types of engagement, such as providing explicit and/or intentional user input (e.g., a natural language request) responsive to one or more portions of the content, and/or by providing non-explicit and/or unintentional user input (e.g., increases in heartrate) responsive to one or more portions of the content. In some implementations, compressed data 206 may also indicate the same or similar metrics corresponding to user engagement data 204.

As disclosed herein, in some implementations generative content may be pre-generated based on one or more previous user interactions. For example, pre-generated generative content may be generated based on historical interaction data 306 prior to user input data 202 being provided by a user. Put another way, pre-generated generative content may be generated and/or stored by remote system 180 and/or database(s) 150 prior to generative model input engine 182 receiving compressed data 206. Generative model input engine 182 may identify pre-generated generative content based on, or independent of, historical interaction data 306. Put another way, generative model input engine 182 may identify pre-generated generative content without receipt and/or processing of historical interaction data 306, and/or may identify pre-generated generative content based on receipt and/or processing of historical interaction data 306. Pre-generating the generative content using a generative model may be done prior to identifying access of the content by the client device, and may be responsive to a frequency, of the given portion interactions, satisfying a threshold. For example, generative content may be generated only in response to a threshold amount of given portion interactions occurring, as opposed to being generated in response to an initial one or more interactions occurring. Put another way, generative content may not be generated if each portion of content has the same or similar interactions occurring, but may be generated based on a frequency of interactions occurring more frequently for a given portion.

Generative model input engine 182 may identify pre-generated generative content that is stored by remote system 180 and/or that is stored by database(s) 150. Generative model input engine 182 may determine, based on processing of historical interaction data 306 and/or compressed data 206, to transmit previously generated content (e.g., in the form of generative content data 208) to client device 100, and may therefore circumvent identification, generation, and/or use of prompt data 302 and/or generative model engine(s) 184 in a current interaction between client device 100 and remote system 180. A scenario may include one or more previous users requesting generative content for a given portion, the (now) pre-generated generative content being generated and stored, and the pre-generated generative content being subsequently suggested when the given portion is being rendered for a current user.

Suggestion of pre-generated generative content may be responsive to general access of an electronic document that includes the given portion that the pre-generated generative content relates to, and/or particular access of the given portion of the electronic document (e.g., refraining from suggesting until the user arrives at the given portion of the electronic document). However, in some implementations, generative model input engine 182 may refrain from using and/or transmitting pre-generated generative content, even if said content is available. For example, if metrics indicate that a current user is engaging with the given portion in a similar (e.g. average) way that they are engaging with other portions of the content, then the pre-generated generative content may not be rendered, and generative content may focus on another portion that the user is engaging more heavily with (e.g., may be generated using prompt data 302 and/or generative model engine(s) 184). Still, in some implementations if metrics indicate that a current user is engaging with the given portion in a similar (e.g. average) way that they are engaging with other portions of the content, the pre-generated generative content may be rendered if a majority of users return to the given portion later, if it is expected that the current user will return to the given portion later, if the given portion is associated with recent events (e.g., news, discoveries, overturnings, etc.), and/or based on other factors.

In some implementations, generative model input engine 182 may generate prompt data 302 based on pre-generated generative content and/or include pre-generated generative content in prompt data 302. For example, in some implementations, generative model input engine 182 may generate and/or identify prompt data 302 based on one or more of pre-generated generative content, compressed data 206, and/or historical interaction data 306.

Prompt data 302 may be provided to generative model engine(s) 184. Prompt data 302 may be generated by generative model input engine 182 and may include historical interaction data 306 (e.g., either directly from historical interaction data engine 186 and/or derivatively from output from generative model input engine 182). Prompt data 302 may include data indicating one or more of a portion of an electronic document being rendered for a user and user input, which may be explicitly and/or intentionally provided in furtherance of causing an automated assistant to perform an action and/or may not be explicitly and/or intentionally provided in furtherance of causing an automated assistant to perform an action. Prompt data 302 may include one or more features of pre-generated generative content (if pre-generated generative content is available).

Generative model engine(s) 184 may process prompt data 302. Generative model engine(s) 184 may generate generative content data 208 based on processing prompt data 302. Generative content data 208 may be generated to be processable by client device 100 in furtherance of rendering generative content and/or a suggestion for rendering thereof. Generative content may include summarizations and expansions of a given portion of content that is indicated by prompt data 302. Generative content may include a conversion of a given portions of content from one form of media (e.g., textual) to another form of media (e.g., video). Generative content may include data which may be processed in furtherance of rendering suggestions for supplementary content such as third party websites, applications, etc. Generative content may include data which may be processed in furtherance of recapping and/or repeating a given portion of content (e.g., rewinding graphical content and/or audible content). As indicated above, generative content data 208 may be formatted by generative model engine(s) 184 to be executable by client device 100 and/or another device receiving generative content data 208.

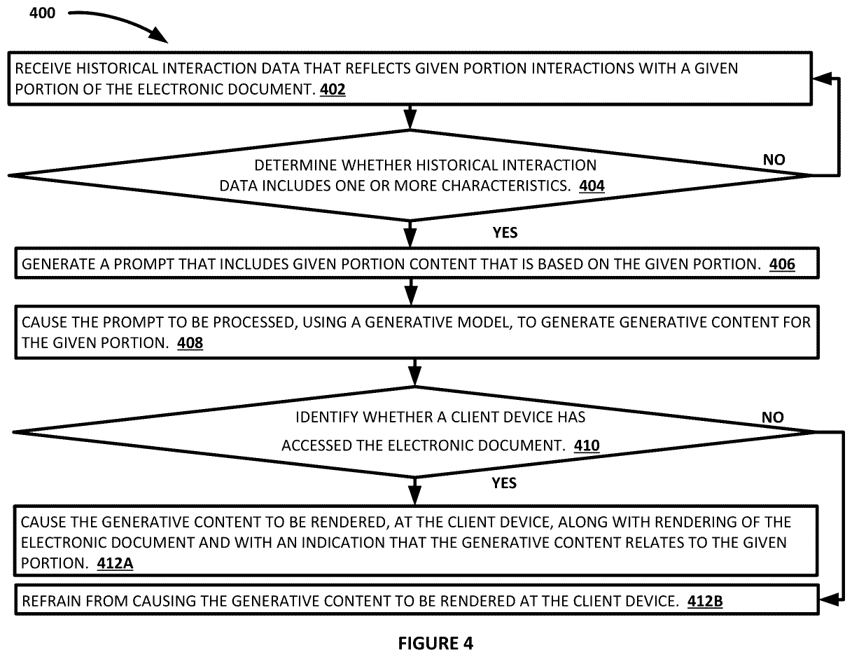

FIG. 4 depicts a flowchart illustrating an example method 400 according to implementations disclosed herein.

Method 400 begins at step 402, during which a processor receives historical interaction data reflecting one or more user engagements with given portions of an electronic document. Historical interaction data may indicate one or more historical engagements, inputs, etc., by one or more users. Historical interaction data may indicate a historical action by a current user and/or a different user. In some implementations, a given portion of an electronic document may be less than an entirety of the electronic document. Put another way, an electronic document may include a given portion and one or more other portions. For example, an electronic document may include other portions that are in addition to the given portion.

In an example scenario, historical interaction data reflecting one or more user engagements with given portions an electronic document may include natural language requests associated with the given portions and/or non-explicit user inputs (e.g., increased squinting while reading the given portion. As an example, the user may provide the natural language input of “please summarize paragraph [0022]” while squinting and reading a long paragraph.

At step 404, a processor processes the historical interaction data and determines, based on the processing, whether the historical interaction data includes one or more characteristics. If the processor determines that historical interaction data includes one or more characteristics, then method 400 proceeds to step 406. If the processor determines that historical interaction data does not include one or more characteristics, then method 400 proceeds to back to step 402.

Characteristics included in historical interaction data may be indications of the duration of time that a user spent engaging with content, indications of user input that a user provided while engaging with content, etc. For example, historical interaction data may include one or more characteristics indicating that a user is spending an inordinate amount of time on a given portion relative to another portion, one or more characteristics indicating that a user is reacting to a given portion in an unusual way relative to one or more other portions, etc.

In some implementations, determining that given portion interactions with the given portion, of the electronic document, have the one or more characteristics comprises: determining the one or more characteristics based on a type of one or more of the most frequent of the one or more natural language user inputs provided during prior electronic interactions. For example, if a type of one or more most frequent natural language inputs during prior electronic interactions is to “please summarize this portion”, then a characteristic of a user spending an inordinate amount of time on that portion may be determined. As another example, if a type of one or more most frequent natural language inputs during prior electronic interactions is to “make this section less confusing” then a characteristic of a user reacting to a given portion in an unusual way relative to other portions may be determined.

At step 406, a processor may generate a prompt that includes given portion content that is based on the given portion. In some implementations, the processor may generate the prompt prior to access of the electronic document by the client device. In some implementations, generating the prompt includes identifying one or more third-party sources that are associated with the given portion and that are distinct from the electronic document, and including, as part of the prompt and along with the given portion content, data derived from the one or more third-party sources.

In a scenario, a prompt may be initially generated based on ongoing user interactions and/or pre-generated based on prior user interactions. For example, a prompt may be pre-generated based on the historical interaction data received in step 402. Further, a prompt may include instructional natural language content. An example of a prompt including instructional natural language content may include “assume that the reader has the following attributes: [user and/or client device attributes], make the following content more precise and more clear: [portion of content]”. The “[portion of content]” element may include a given portion of content that is being rendered. The “[user and/or client device attributes]” may include attributes determined by cached data, such as cookies, preferences, and/or other characteristics. An example of a user attribute may include one or more of age, occupation, family status, nationality, and/or another attribute. An example of a client device attribute may include age, hardware, software, serial number, OS type, mobile carrier, battery level, and/or another attribute.

Pre-generated prompts may receive data indicating given portions of content that are being rendered and/or pre-generated generative content. For example, a pre-generated prompt may be the same as discussed above, but instead of “[portion of content]”, it may receive “[portion of pre-generated generative content]”. Accordingly, generative content may be initially generated based on user and/or client device attributes and a given portion of content. Additionally, (now) pre-generated generative content may be identically provided in subsequent iterations with or without prompting. Further (now) pre-generated generative content may be modified and provided in subsequent iterations with prompting.

Moreover, pre-generated prompts may be refined and/or modified based on user and/or client device attributes. For example, if data indicates that a user speaks a certain language, such as English, then a pre-generated prompt that was initially generated in a Spanish dialect may be refined and/or modified based on the user and/or client device primarily using English language. As another example, pre-generated prompts may be refined and/or modified based on given portions of content that a user is engaging with, such that “assume that the reader has the following attributes: [user and/or client device attributes], make the following content more precise and more clear: [portion of content]” may adjust to “assume that the reader has the following attributes: [user and/or client device attributes], make the following content more expansive and provide graphical and/or textual media conversions: [portion of content]”.

Additionally, a prompt may be based on one or more characteristics discussed herein (e.g., the amount of time that a user has spent on a given portion of content). For example, a prompt may be generated (and/or identified, if pre-generated) responsive to a user allotting a threshold amount of time to a given portion and/or having a certain reaction to a given portion and/or reacting to content in a given way. In some instances, instructional natural language content may be based on one or more natural language inputs provided during prior electronic interactions with content by one or more users of one or more devices. For example, a prompt including the feature of “make the following content more expansive” may be responsive to one or more natural language requests to “please generate additional content related to this portion”. Alternatively, a prompt including the feature of “make the following content more concise” may be responsive to one or more natural language requests to “please summarize this portion” outnumbering natural language requests to one or more natural language requests to “please generate additional content related to this portion”.

In some implementations, generating the prompt comprises: identifying instruction natural language content that corresponds to the one or more characteristics; and including, as part of the prompt and along with the given portion content, the instructional natural language content, wherein including the instructional natural language content as part of the prompt and along with the given portion content is responsive to the instructional natural language content corresponding to the one or more characteristics.

As an example, instructional natural language content can be “add additional details about” in a prompt of the form “add additional details about [this given portion]”. In the immediately preceding example, the instructional natural language content of “add additional details about” can be determined based on the determined characteristic(s) of the historical interaction data. For example, if the characteristic(s) of the historical interaction data indicate that users frequently copy the portion and/or issue search(es) based on the portion, instructional data can be included that request expansion/more detail about the portion (e.g., “add additional details about” or similar language).

As another example, instructional natural language content can be “create a more clear and concise summary of” in a prompt of the form “create a more clear and concise summary of [this given portion]”. In the immediately preceding example, the instructional natural language content of “create a more clear and concise summary of” can be determined based on the determined characteristic(s) of the historical interaction data. For example, if the characteristic(s) of the historical interaction data indicate that users spend a significantly greater quantity of time on the portion than on other portions, instructional data can be included that request a summary of and/or more clarity about the portion (e.g., “add additional details about” or similar language). More generally, in various implementations, in generating the prompt at step 406, the prompt can be generated such that instructional language, that is included in the prompt, is tailored to characteristic(s), of the given portion, that are determined based on the historical interaction data

At step 408, a processor may cause the prompt to be processed, using a generative model, to generate generative content for the given portion. In some implementations this can include transmitting the prompt to an application programming interface (API) for the generative model. In some implementations, this can include actively processing the prompt using the generative model.

In a scenario, the prompt of “assume that the reader has the following attributes: [user and/or client device attributes], make the following content more precise and more clear: [portion of content]” may be processed using a generative model in furtherance of generating generative content for a given portion. As an example, “assume that the reader has the following attributes: [User age: 21, Client device: Google Pixel], make the following content more precise and more clear: [paragraph 0081]” may be processed using a generative model to get a summarization of paragraph 0081, which may include bullet points, media conversions (e.g., videos), and/or other generative content features. As another example, “assume that the reader has the following attributes: [User age: 21, Client device: Google Pixel], make the following content more precise and more clear: [paragraph 0081+pre-generated content #2]” may be processed using a generative model to get a summarization of paragraph 0081 based on an iteration of previously generated content.

At step 410, a processor may identify whether a client device has accessed the electronic document. If the processor identifies that, yes, the client device has accessed the electronic document, then method 400 proceeds to step 412A. If the processor identifies that, no, the client device has not accessed the electronic document, then method 400 proceeds to step 412B. Access of the electronic document may occur subsequent to steps preceding step 410, such that generative content for a given portion may be generated prior to a current user interaction, and may therefore be readily provided based on the current user interaction. As disclosed herein, this may reduce latency between a user's initial request and a final response to the request.

At step 412A, a processor may cause the generative content to be rendered, at the client device, along with rendering of the electronic document and with an indication that the generative content relates to the given portion. As disclosed herein, this may reduce unnecessary usage of computational resources, as subsequent and/or iterative generation of output may be reduced responsive to the aggregation of user interactions subsequent to an initial request being mitigated or reduced based on the generative content proactively resolving the necessity of the user interactions subsequent to the initial request.

At step 412B, a processor determines to refrain from causing the generative content to be rendered at the client device. For example, in some implementations, generative content may not be rendered unless a user accesses an electronic document and/or a given portion of the electronic document that the generative content relates to. However, in some implementations, generative content may be rendered even if a user has not yet accessed an electronic document and/or a given portion of the electronic document that the generative content relates thereto.

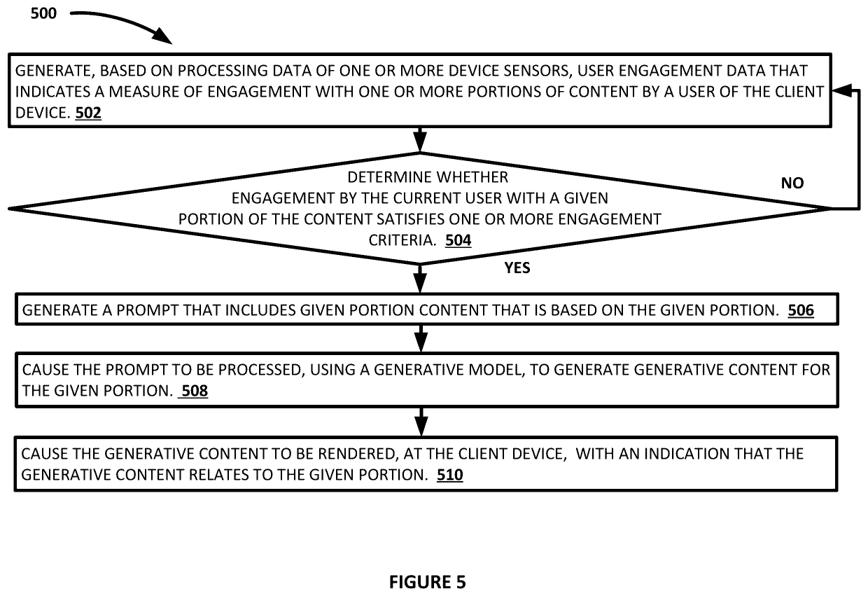

FIG. 5 depicts another flow chart illustrating another example method 500 according to implementations disclosed herein.

Method 500 begins at step 502, during which a processor generates, based on processing data of one or more device sensors, user engagement data that indicates a measure of engagement with one or more portions of content by a user of the client device. In some implementations, one or more of the device sensors are included in a wearable device and/or are included in an internet of things (IoT) device. In some implementations, one or more of the device sensors are included in the client device.

At step 504, a processor determines whether engagement by the current user with a given portion of the content satisfies one or more engagement criteria. If the processor determines that, yes, engagement by the current user with a given portion of the content satisfies one or more engagement criteria, the method 500 proceeds to step 506. If the processor determines that, no, engagement by the current user with a given portion of the content does not satisfy one or more engagement criteria, the method 500 proceeds back to step 502. In some implementations, a processor may identify, based on processing the user engagement data, a lack of user engagement by the current user with the given portion of the content, and determining that engagement by the current user with the given portion of the content satisfies one or more engagement criteria may be based on identifying the lack of user engagement with the given portion of the content. Engagement criteria may include temporal engagement metrics, engagement intensity metrics, engagement type metrics, and/or other engagement metrics, disclosed herein.

At step 506, a processor generates a prompt that includes given portion of content that is based on the given portion. Given portion content may include non-verbatim and/or verbatim representations of content that is included in the given portion. For example, given portion content may include a category, length, subject, etc., of the given portion.

At step 508, a processor causes the prompt to be processed, using a generative model, to generate generative content for the given portion. In some implementations, the generative content only corresponds to the given portion of the content. In some implementations, the generative content is personalized to the user based on one or more of the current user's past interactions with similar content, the current user's preferences, the current user's knowledge level, the current user's environmental context, and/or other user attribute(s). For example, block 506 can include generating the prompt to also include natural language that describes user attribute(s), resulting in generated generative content being personalized to the user.

At step 510, a processor causes the generative content to be rendered, at the client device, with an indication that the generative content relates to the given portion. In some implementations, rendering of the generative content may be preceded by generation of a GUI element, which when selected by a user, causes the generative content to be rendered. In some implementations, the GUI element may be a timer and/or other indicator, indicating that upon some event (e.g., the timer running out), the generative content may automatically render and/or the GUI element may disappear.

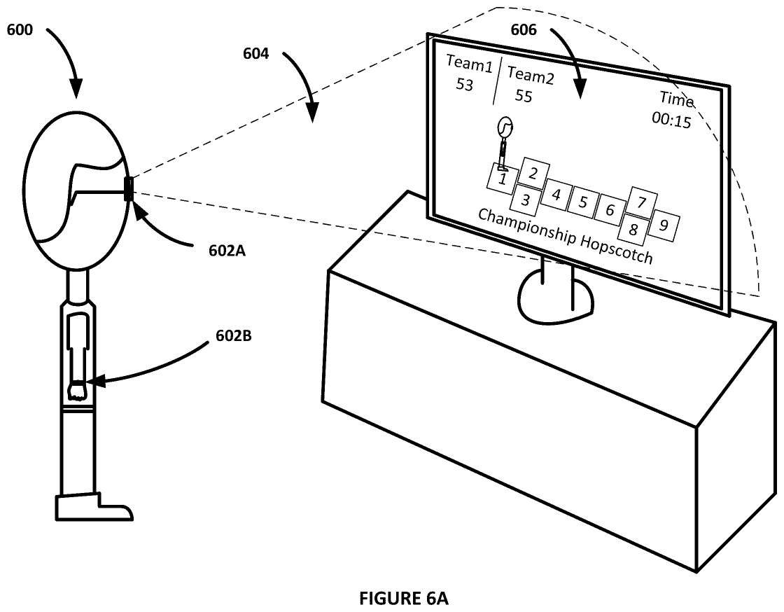

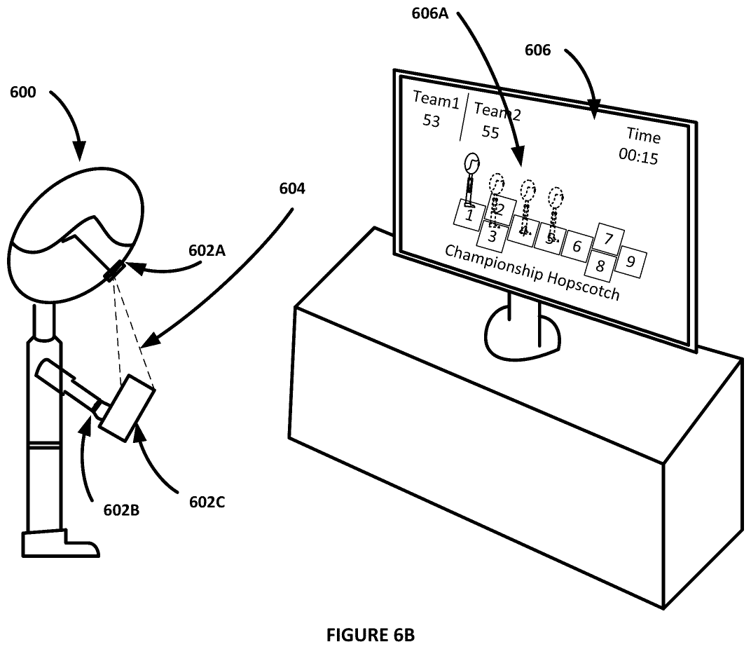

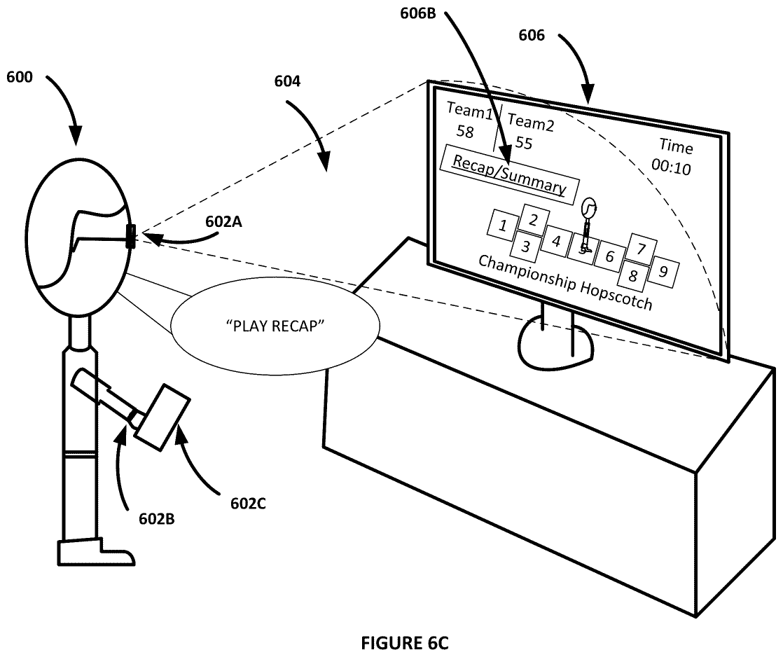

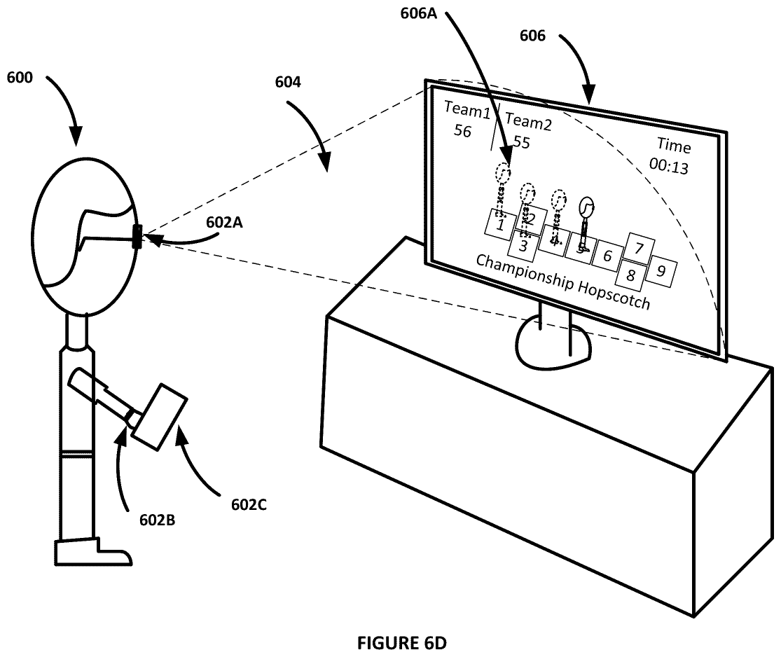

FIGS. 6A-6D depict an environment in which one or more sensors of one or more devices identify user input indicative of user engagement with content, and generative content is suggested based on the engagement.

FIG. 6A depicts user 600 engaging with content 606. Engagement by the user 600 with content 606 may be determined based on sensor data generated by wearable computing glasses 602A and/or wearable computing watch 602B. For example, sensor data generated by wearable computing glasses 602A may indicate that user 600's eye is focused on content 606. As another example, sensor data generated by wearable computing watch 602B may indicate that a user's heartrate is increasing responsive to content 606. Based on sensor data generated by wearable computing glasses 602A and/or wearable computing watch 602B, a processor can determine that user 600 is engaging with content 606. A computing device, such as wearable computing glasses 602A may process sensor data to identify attributes of user 600's engagement with content 606, including attentiveness, interest, confusion, etc.

FIG. 6B depicts user 600 engaging with device 602C in lieu of engaging with content 606. A given portion 606A of content 606 is being rendered, however, user 600 is not engaging with the given portion 606A. One or more sensors of wearable computing glasses 602A, wearable computing watch 602B, and/or device 602C may generate and/or identify data indicating user engagement with device 602C. Further, one or more sensors of wearable computing glasses 602A, wearable computing watch 602B, and/or device 602C may generate and/or identify data indicating the lack of user engagement with given content portion 606A. Accordingly, one or more sensors of wearable computing glasses 602A, wearable computing watch 602B, and/or device 602C may generate and/or identify data indicating user engagement with device 602C in lieu of user engagement with given portion 606A.

FIG. 6C depicts user 600 engaging with content 606 and recognizing that a generative content suggestion 606B associated with content 606 is now being rendered. Wearable computing glasses 602A may identify user gaze 604 turning back towards content 606. Other attributes of user engagement may indicate confusion, e.g., such as confusion about the change of content 606 that user 600 missed. User 600 may provide input of “play recap” corresponding to generative content suggestion 606B “Recap/Summary” in furtherance of causing generative content to be rendered that recaps and/or summarizes the missed given portion of content. As disclosed herein, in some implementations, generative content suggestion 606B may only be presented if a quality metric of missed content satisfies a threshold. For example, if the given portion 606A was not of sufficient quality (e.g., a processor determines that nothing of interest to the user occurred), then generative content suggestion 606B may not be rendered. In a scenario, if content being rendered is a televised hopscotch tournament, and a portion of the content missed was only a group huddle, then the quality metric may not be satisfied, and generative content suggestion 606B may not be rendered. By contrast, if the portion of content missed was a popular hopscotch play, then the quality metric may be satisfied, and the generative content suggestion 606B may be rendered. As another example, if a live virtual meeting includes a given portion of content in which one or more users are waiting in a lobby without discussing significant topics, then a generative content suggestion may not be provided, but if the live virtual meeting includes one or more users waiting in the lobby and discussing a significant topic, then a generative content suggestion recapping the missed given portion may be rendered.

FIG. 6D depicts user 600 engaging with the given content portion 606A that they previously missed because they were engaging with device 602C. The given content portion 606A that they previously missed is rendered based on the user's 600 selection of the generative content suggestion 606B in FIG. 6C. Generative content may include summaries, expansions, etc., of content, and may also include recaps and/or predictions of content. For example, in some implementations, summarizations of missed content may be generated. As a scenario, a missed portion of a basketball game having a duration of one minute may be summarized in a recap having a duration of 15 seconds.

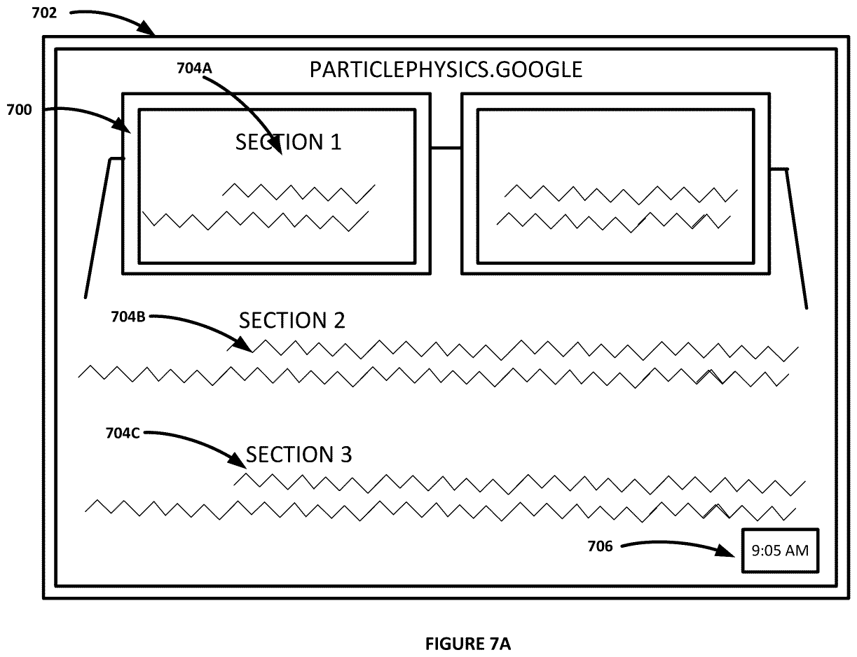

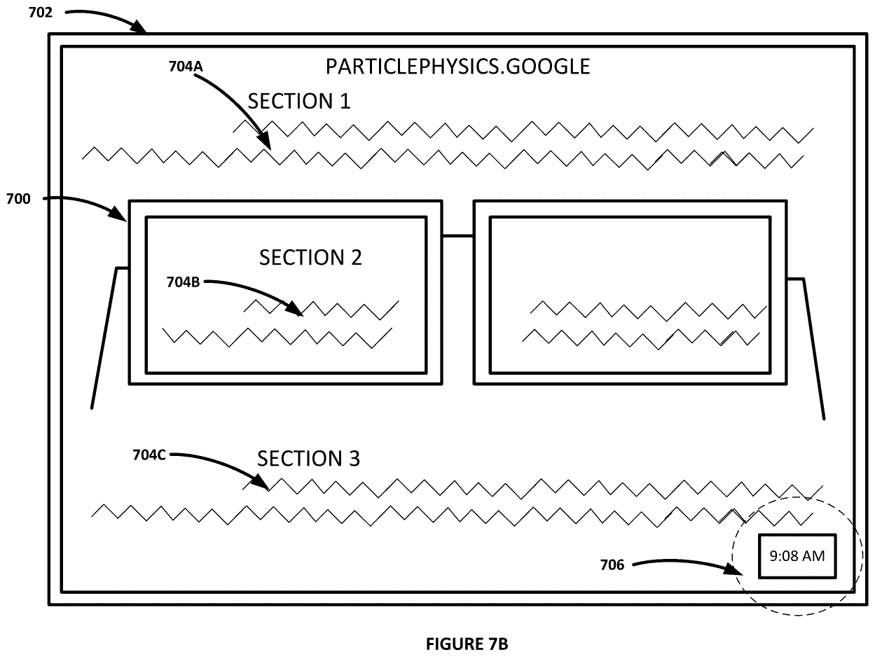

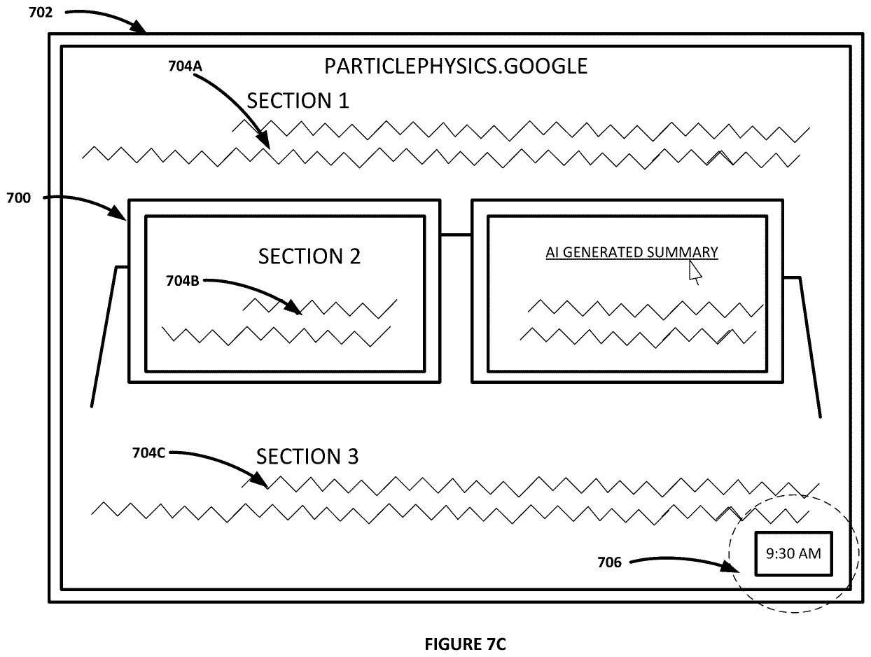

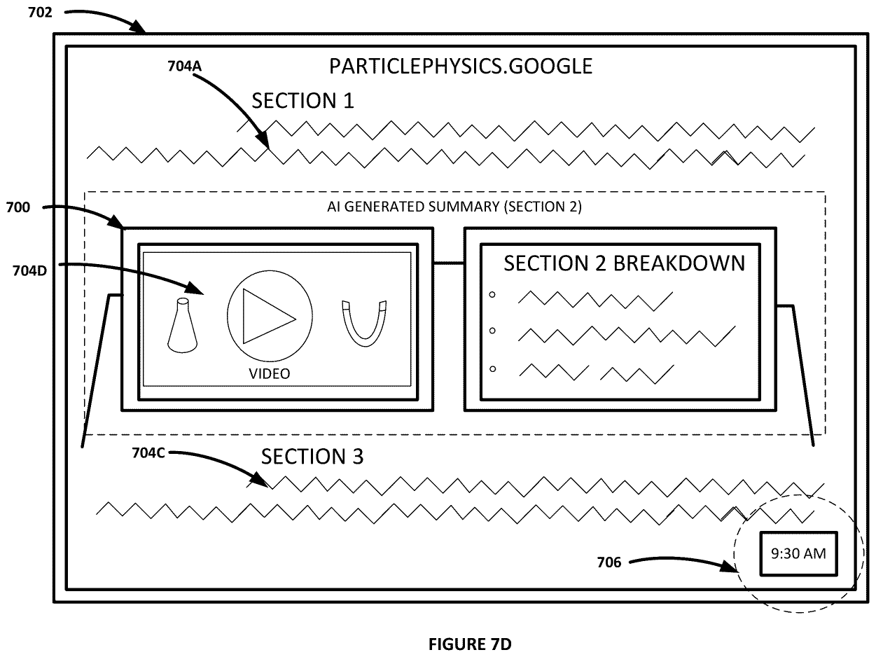

FIGS. 7A-7D depict another environment in which user engagement with content is determined and generative content is suggested based on the determined engagement.

FIG. 7A depicts an environment from the perspective of a user wearing wearable computing glasses 700. Monitor 702 may render content sections 704A-704C, and may have a clock 706 at the bottom right corner. 704A may correspond to a first section of an article about physics. 704B may correspond to a second section of an article about physics. 704C may correspond to a third section of an article about physics. The user may begin reading the first section 704A at 9:05 AM, as indicated by the clock 706.

One or more sensors of wearable computing glasses 700 may identify user engagement with section one 704A. For example, not only may one or more sensors of wearable computing glasses 700 identify that the gaze of wearable computing glasses 700 aligns with section one 704A, but they may also identify characteristics of a user's eye (e.g., glazing over, repetitive positioning over section one 704A, looks of confusion, indications of distress and/or tiredness, etc.) that indicate user engagement with section one 704A. Accordingly, wearable computing glasses 700 may identify and/or generate data indicating user engagement with a given section, such as section one 704A. In some implementations, sensor data from other devices may also be used to identify user engagement. For example, wearable computing glasses 700 may identify that a user's retina is focusing on section one 704A, and a camera of monitor 702 (and/or a camera of an IoT device) may identify that the user is not providing a gesture indicative of confusion and/or frustration.

FIG. 7B depicts section two 704B as being within a focus of wearable computing glasses 700. As indicated by clock 706 in the bottom right corner of monitor 702, the user may be engaging with section two 704B at 9:08 AM. Recall that clock 706 in FIG. 7A depicted a time of 9:05 AM, indicating that a user was able to engage with section one 704A for about 3 minutes prior to moving onto section two 704B. Accordingly, an average amount of time per section for this physics article may be around 3 minutes. Further, as disclosed herein, it is understood that previously generated averages of one or more users that have previously engaged with sections one through three 704A-704C may also be considered, and that an estimate of an average amount of time per section for a given article is not limited to being identified via an averaging being calculated in a current section. As disclosed herein, both current user engagements and/or historic user engagements may be used to determine when and/or if rendering of generative content is appropriate, and each of the previously generated averages and averages being calculated in the current session may be processed.

FIG. 7C is very similar to FIG. 7B, however, clock 706 indicates that a user may still be engaging with section two 704B. Accordingly, the time having passed since the wearable computing glasses 700 focused on section two 704B in FIG. 7B and FIG. 7C is approximately 22 minutes, which is significantly greater than the 3 minute average previously discussed. A suggestion of “AI generated summary” is overlaid on section two 704B. The suggestion overlaid on section two 704B may be rendered based on user engagement with section 2.

For example, the suggestion may be rendered based on the user engagement with section 2 exceeding the average amount of time spent per section thus far. Put another way, wearable computing glasses 700 may identify that a user's retina is continuously refocusing on section two 704B, and a camera of monitor 702 may identify that the user is providing a gesture indicative of confusion and/or frustration. As another example, the suggestion may be rendered based on historical interaction data indicating one or more other users spent an inordinate amount and/or duration of engagement with section 2 704B. Additionally, in some implementations, the suggestion and/or generative content to be rendered based on selection thereof may be pre-generated based on the historical interaction data.

FIG. 7D includes an AI generated content (e.g., in this instance, a summary) 704D of section two. AI generated summary 704D may be rendered based on user selection of an indication of availability of AI generated content (e.g., similar to the indication of “Recap/Summary” of FIG. 6C), and/or may be automatically rendered independent of user interaction with an automated assistant. AI generated summary 704D may include features of section two 704B, and/or may only include distinct generative content based on section two 704B. For example, AI generated summary 704D may include a video summarization of section two 704B, which was not included in section two 704B (e.g., section two 704B may be all textual). AI generated summary 704D may also include a section two breakdown, which may or may not include verbatim aspects of section two 704B. For example, AI generated summary 704D may textually reformat the textual aspects of section two 704B and/or provide additional content relevant to section two 704B.

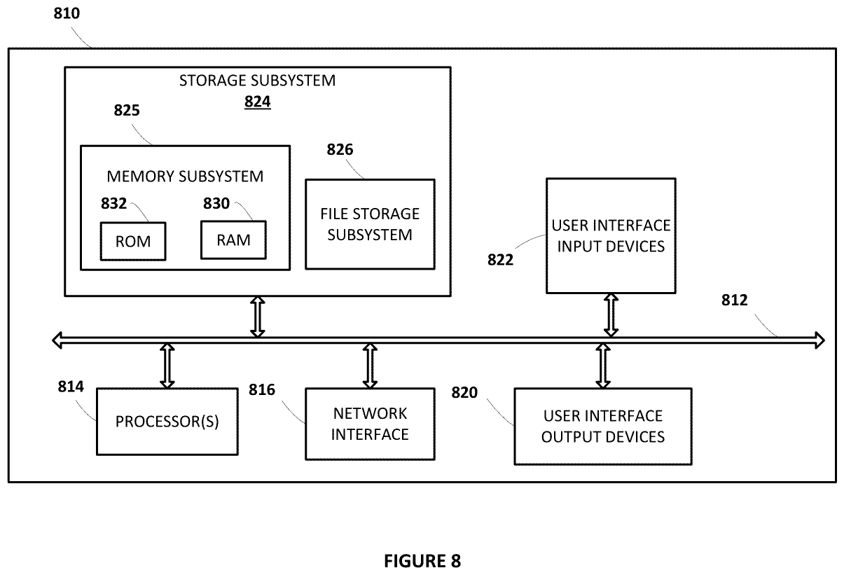

Turning now to FIG. 8, a block diagram of an example computing device 810 that may optionally be utilized to perform one or more aspects of techniques described herein. In some implementations, one or more of a client device, remote system component(s), and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods disclosed herein, as well as to implement various components depicted in other figures.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

Some implementations herein are directed to receiving, at a client device (e.g., having at least memory and processor(s)), input from a user, generating, at the client device, data that indicates the natural language input, transmitting the data that indicates the natural language input from the client device to a remote system, receiving, at the client device, generative content data that corresponds to the data that indicates that natural language input, and causing, at the client device, generative content to be suggested based on the generative content data.

For example, a client device may receive input from a user (indicating at least one or more of user engagement with content and/or a natural language input in furtherance of causing the content to be rendered), transmit data indicative of this input from the user to a remote system, receive generative content data from the remote system, and suggest generative content based on the generative content data. In various implementations, the remote system may determine historical interactions by one or more users with the content and may suggest generative content based on historical interaction data that indicates the historical engagements. For example, based on one or more previous users heavily engaging with a given portion of content (relative to other portions of content), generative content may be suggested to a user that is currently engaging with the content. In some implementations, the client device may determine real-time engagement by the user that is currently requesting and/or viewing the content, and may cause generative content to be provided based on the real-time engagement (including the lack thereof).

Various methods, and systems and non-transitory computer readable mediums for execution thereof are contemplated herein.

In some implementations, a method may be implemented by one or more processors and may comprise: determining, based on processing historical interaction data for an electronic document, that the historical interaction data, that reflects given portion interactions with a given portion of the electronic document, includes one or more characteristics, wherein the historical interaction data is generated based on prior electronic interactions with the electronic document by multiple users of multiple client devices, and wherein the given portion is less than an entirety of the electronic document; and in response to determining that the historical interaction data includes the one or more characteristics: generating a prompt that includes given portion content that is based on the given portion; and causing the prompt to be processed, using a generative model, to generate generative content for the given portion; and in response to identifying electronic access of the electronic document by a client device: causing the generative content to be rendered, at the client device, along with rendering of the electronic document and with an indication that the generative content relates to the given portion.

In some implementations, generating the prompt comprises: identifying instruction natural language content that corresponds to the one or more characteristics; and including, as part of the prompt and along with the given portion content, the instructional natural language content, wherein including the instructional natural language content as part of the prompt and along with the given portion content is responsive to the instructional natural language content corresponding to the one or more characteristics.

In some implementations, the instructional natural language content is based on one or more natural language user inputs provided during the prior electronic interactions with the electronic document by one or more of the multiple users of multiple client devices. In some implementations, determining that given portion interactions with the given portion, of the electronic document, have the one or more characteristics comprises: determining the one or more characteristics based a type of one or more of the most frequent of the one or more natural language user inputs provided during the prior electronic interactions.

In some implementations, the one or more natural language user inputs include one or more of a request for content that expands content included in the given portion of the electronic document and/or a request for content that summarizes content included in the given portion of the electronic document. In some implementations, determining that given portion interactions with the given portion, of the electronic document, have the one or more characteristics comprises: identifying one or more other portion interactions with other portions of the electronic document, and determining the one or more characteristics based on how the given portion interactions with the given portion of the electronic document differ from the one or more other portion interactions with the other portions of the electronic document.

In some implementations, determining how the given portion interactions with the given portion of the electronic document differ from the one or more other portion interactions with the other portions of the electronic document comprises: identifying that the other portion interactions lasted a first amount of time, identifying that the given portion interactions lasted a second amount of time that is greater than the first amount of time, and determining that the given portion interactions with the given portion of the electronic document differ from the one or more other portion interactions with the other portions of the electronic document based on identifying the given portion interactions lasted the second amount of time that is greater than the first amount of time.

In some implementations, determining that the given portion interactions with the given portion of the electronic document differ from the one or more other portion interactions with the other portions of the electronic document comprises: identifying that the other portion interactions included one or more of the multiple users selecting the one or more other portions a first quantity of times, identifying that the given portion interactions included the one or more of the multiple users selecting the given portion a second quantity of times, determining that the second quantity of times the given portion that was selected is greater than the first quantity of times the one or more other portions that was selected, and determining that the given portion interactions with the given portion of the electronic document differ with the one or more other portion interactions with the other portions of the electronic document based on the second quantity of times the given portion that was selected being greater than the first quantity of times the one or more other portions that was selected.

In some implementations, selecting the given portion includes selecting the given portion in furtherance of annotating the given portion and/or executing a search query based on the given portion. In some implementations, selecting the one or more other portions includes selecting the one or more other portions in furtherance of annotating the one or more other portions and/or executing a search query based on the one or more other portions.

In some implementations, generating the prompt comprises: identifying one or more attributes that are associated with the client device; and including, as part of the prompt and along with the given portion content and the instructional language content, the one or more attributes, wherein including one or more attributes as part of the prompt and along with the given portion content and the instructional natural language content is responsive to the access of the electronic document being by the client device.

In some implementations, the one or more attributes include one or more account attributes that are associated with an account that is verified at the client device. In some implementations, identifying one or more attributes that are associated with the client device is responsive to: identifying a user of the client device is logged into the client device, wherein the one or more attributes that are associated with the client device are associated with a profile, of the user, that is stored on the client device.

In some implementations, identifying the user of the client device is logged into the client device comprises: identifying one or more of an audible input, graphical input, and/or haptic input, and determining that the one or more of the audible input, graphical input, and/or haptic input is exclusively associated with the user.

In some implementations, causing the generative content to be rendered at one or more of the interfaces comprises: identifying, based on the one or more identified attributes that are associated with the client device, a particular interface of the client device, and rendering the generative content at the particular interface in lieu of one or more other interfaces of the client device.

In some implementations, the one or more identified attributes include client device environment data. In some implementations, generating the prompt occurs responsive to access of the electronic document by the client device.

In some implementations, the method further comprises prior to access of the electronic document by the client device: generating the given portion content based on processing the given portion using the generative model or an alternative generative model.

In some implementations, the generative content is generated prior to identifying electronic access of the content by the client device. In some implementations, generating the generative content using the generative model and prior to identifying access of the content by the client device is in response to a frequency, of the given portion interactions, satisfying a threshold.

In some implementations, the method further comprises: prior to generating the generative content: identifying the given portion corresponds to a particular content category, determining whether to generate the generative content based on the given portion corresponding to the particular content category, wherein generating the generative content using the generative model is based on determining to generate the generative content in response to the given portion corresponding to the particular content category.

In some implementations, the prompt includes natural language textual input, wherein the generative model is an image or video generation model, and wherein in generating the generative content the natural language textual input is applied to the generative model to generate one or more image frames that are included in the generative content. In some implementations, the prompt includes one or more frames of video input, wherein the generative model is a natural language content generation model, and wherein generating the generative content the one or more frames of video input are applied to the generative model to generate natural language content that is included in the generative content.

In some implementations, generating the prompt comprises: identifying one or more third-party sources that are associated with the given portion and that are distinct from the electronic document, and including, as part of the prompt and along with the given portion content, data derived from the one or more third-party sources. In some implementations, generating the prompt comprises: determining whether the given portion satisfies a content quality threshold, and generating, based on determining that the given portion satisfies a content quality threshold, the generative content.

In some implementations, the electronic document includes a real-time virtual meeting that one or more of the multiple users are subscribed to, and wherein the given portion includes one or more portions of the virtual meeting that have previously occurred, and wherein generating the prompt comprises: determining whether the one or more portions of the virtual meeting that have previously occurred satisfy the content quality threshold, and generating, based on determining that the one or more portions of the virtual meeting that have previously occurred satisfies the content quality threshold the generative content.

A method implemented by one or more processors may comprise: generating, based on processing data of one or more device sensors, user engagement data that indicates a measure of engagement with one or more portions of content by a user of the client device; determining, based on processing the user engagement data, that engagement by the current user of the user device with a given portion of the one or more portions satisfies one or more engagement criteria; in response to determining that engagement by the current user of the user device with a given portion of the one or more portions satisfies one or more engagement criteria: generating a prompt that includes given portion content that is based on the given portion; causing the prompt to be processed, using a generative model, to generate generative content for the given portion; and causing the generative content to be rendered at the client device and with an indication that the generative content relates to the given portion.

In some implementations, the method may further comprise identifying, based on processing the user engagement data, a lack of user engagement by the current user with the given portion of the content, wherein generating the generative content is based on identifying the lack of user engagement with the given portion of the content. In some implementations, the generative content only corresponds to the given portion of the content. In some implementations, the generative content is personalized to the user based on one or more of the current user's past interactions with similar content, the current user's preferences, the current user's knowledge level, and/or the current user's environmental context. In some implementations, one or more of the device sensors are included in the client device. In some implementations, one or more of the device sensors are included in a wearable device or are included in an internet of things (IoT) device.

We claim:

1. A method implemented by one or more processors, the method comprising:
determining, based on processing historical interaction data for an electronic document, that the historical interaction data, that reflects given portion interactions with a given portion of the electronic document, includes one or more characteristics,
wherein the historical interaction data is generated based on prior electronic interactions with the electronic document by multiple users of multiple client devices, and
wherein the given portion is less than an entirety of the electronic document;
in response to determining that the historical interaction data includes the one or more characteristics:
generating a prompt that includes given portion content that is based on the given portion; and
causing the prompt to be processed, using a generative model, to generate generative content for the given portion; and
in response to identifying electronic access of the electronic document by a client device:
causing the generative content to be rendered, at the client device, along with rendering of the electronic document and with an indication that the generative content relates to the given portion.

2. The method of claim 1, wherein generating the prompt comprises:
identifying instruction natural language content that corresponds to the one or more characteristics; and
including, as part of the prompt and along with the given portion content, the instructional natural language content, wherein including the instructional natural language content as part of the prompt and along with the given portion content is responsive to the instructional natural language content corresponding to the one or more characteristics.

3. The method of claim 2, wherein the instructional natural language content is based on one or more natural language user inputs provided during the prior electronic interactions with the electronic document by one or more of the multiple users of multiple client devices.

4. The method of claim 3, wherein determining that given portion interactions with the given portion, of the electronic document, have the one or more characteristics comprises:
determining the one or more characteristics based a type of one or more of the most frequent of the one or more natural language user inputs provided during the prior electronic interactions.

5. The method of claim 4, wherein the one or more natural language user inputs include one or more of a request for content that expands content included in the given portion of the electronic document and/or a request for content that summarizes content included in the given portion of the electronic document.

6. The method of claim 2, wherein determining that given portion interactions with the given portion, of the electronic document, have the one or more characteristics comprises:
identifying one or more other portion interactions with other portions of the electronic document, and
determining the one or more characteristics based on how the given portion interactions with the given portion of the electronic document differ from the one or more other portion interactions with the other portions of the electronic document.

7. The method of claim 6, wherein determining how the given portion interactions with the given portion of the electronic document differ from the one or more other portion interactions with the other portions of the electronic document comprises:
identifying that the other portion interactions lasted a first amount of time,
identifying that the given portion interactions lasted a second amount of time that is greater than the first amount of time, and
determining that the given portion interactions with the given portion of the electronic document differ from the one or more other portion interactions with the other portions of the electronic document based on identifying the given portion interactions lasted the second amount of time that is greater than the first amount of time.

8. The method of claim 6, wherein determining that the given portion interactions with the given portion of the electronic document differ from the one or more other portion interactions with the other portions of the electronic document comprises:
identifying that the other portion interactions included one or more of the multiple users selecting the one or more other portions a first quantity of times,
identifying that the given portion interactions included the one or more of the multiple users selecting the given portion a second quantity of times,
determining that the second quantity of times the given portion that was selected is greater than the first quantity of times the one or more other portions that was selected, and
determining that the given portion interactions with the given portion of the electronic document differ with the one or more other portion interactions with the other portions of the electronic document based on the second quantity of times the given portion that was selected being greater than the first quantity of times the one or more other portions that was selected.

9. The method of claim 8, wherein selecting the given portion includes selecting the given portion in furtherance of annotating the given portion and/or executing a search query based on the given portion.

10. The method of claim 8, wherein selecting the one or more other portions includes selecting the one or more other portions in furtherance of annotating the one or more other portions and/or executing a search query based on the one or more other portions.

11. The method of claim 2, wherein generating the prompt comprises:
identifying one or more attributes that are associated with the client device; and
including, as part of the prompt and along with the given portion content and the instructional language content, the one or more attributes, wherein including one or more attributes as part of the prompt and along with the given portion content and the instructional natural language content is responsive to the access of the electronic document being by the client device.

12. The method of claim 11, wherein the one or more attributes include one or more account attributes that are associated with an account that is verified at the client device.

13. The method of claim 11, wherein identifying one or more attributes that are associated with the client device is responsive to:
identifying a user of the client device is logged into the client device, wherein the one or more attributes that are associated with the client device are associated with a profile, of the user, that is stored on the client device.

14. The method of claim 13, wherein identifying the user of the client device is logged into the client device comprises:
identifying one or more of an audible input, graphical input, and/or haptic input, and
determining that the one or more of the audible input, graphical input, and/or haptic input is exclusively associated with the user.

15. The method of claim 11, wherein causing the generative content to be rendered comprises:
identifying, based on the one or more identified attributes that are associated with the client device, a particular interface of the client device, and
rendering the generative content at the particular interface in lieu of one or more other interfaces of the client device.

16. The method of claim 15, wherein the one or more identified attributes include client device environment data.

17. The method of claim 1, wherein generating the prompt occurs responsive to access of the electronic document by the client device.

18. The method of claim 17, further comprising:
prior to access of the electronic document by the client device:
generating the given portion content based on processing the given portion using the generative model or an alternative generative model.

19. The method of claim 1, wherein the generative content is generated prior to identifying electronic access of the content by the client device, and wherein generating the generative content using the generative model and prior to identifying access of the content by the client device is in response to a frequency, of the given portion interactions, satisfying a threshold.

20. A method implemented by one or more processors comprising:
generating, based on processing data of one or more device sensors, user engagement data that indicates a measure of engagement with one or more portions of content by a user of the client device;
determining, based on processing the user engagement data, that engagement by the user of the user device with the given portion of the one or more portions satisfies one or more engagement criteria;
in response to determining that engagement by the user of the user device with a given portion of the one or more portions satisfies one or more engagement criteria:
generating a prompt that includes given portion content that is based on the given portion;
causing the prompt to be processed, using a generative model, to generate generative content for the given portion; and
causing the generative content to be rendered at the client device and with an indication that the generative content relates to the given portion.
